(19) United States
(12) Patent Application Publication
(10) Pub. No.: US 2024/0358194 A1
(43) Pub. Date: Oct. 31, 2024

(54) DEVICE FOR FILLING AND COMPACTING POWDER OR GRANULES

(71) Applicant: ETZINGER ENGINEERING, Eschen (LI)

(72) Inventor: Christian Etzinger, Eschen (LI)

(21) Appl. No.: 18/645,693

(22) Filed: Apr. 25, 2024

(30) Foreign Application Priority Data
Apr. 26, 2023 (EP) 23169965.3

(51) Int. Cl. A47J 42/40; A47J 42/04

(52) U.S. Cl. CPC A47J 42/40; A47J 42/04

(57) ABSTRACT

The present invention relates to a device for filling and compacting powder or granules into a container. The powder or granules are provided by a separate apparatus and wherein the device comprises a lateral surface, at least one inlet opening for admitting the powder or granules into the device, at least one outlet opening for discharging the powder or granules from the device into the container, an interior. The interior is bounded at least by the lateral surface and connects the inlet opening to the outlet opening. A movable plunger for compacting powder or granules is contained in the container, with at least one fastening element, wherein the fastening element is provided to cooperate with a corresponding counterpart on the separate apparatus and provide temporary fastening of the device to the separate apparatus. At least one holding element is provided to temporarily hold the container on the device.

### FIELD OF THE INVENTION

The present invention relates to a device for filling and compacting powder or granules, in particular coffee powder, into a container, in particular a coffee capsule, wherein the powder or granules are provided by a separate apparatus.

### BACKGROUND OF THE INVENTION

Systems consisting of a grinder and a filling device, which fills the powder provided by the grinder into a corresponding vessel, are known from the prior art.

For example, the publications DE 10 2018 009 992 A1 and WO 2016/029355 A1 disclose systems comprising a coffee grinder and a filling device that fills the coffee powder provided by the coffee grinder into refillable coffee capsules.

A disadvantage of the systems of the prior art is that they are systems in which the grinder, in particular the coffee grinder, is permanently installed with the filling device. It is therefore not possible for the user, for example, to separate the filling device from the grinder and use the filling device as a stand-alone device. However, such an application could be of interest to the user if the substance to be filled is already in powder form (e.g. purchased coffee powder) and a preliminary grinding step is not required.

Another disadvantage of the systems of the prior art is that these systems are large, heavy and unwieldy and are therefore unsuitable for applications where weight and space must be saved (e.g. if the user only has limited space in their luggage for a vacation trip).

### OBJECT OF THE INVENTION

It is therefore the object of the invention to provide a device for filling and compacting powder or granules and a system comprising the device according to the invention and a grinder which can be handled, which overcomes the disadvantages of the prior art, in particular in the light of flexible use of the system parts and ease of carrying.

This object is solved by the realization of at least some of the characterizing features of the independent claims. Features which further develop the invention in an alternative or advantageous manner are to be taken from some of the other features of the independent claims and the dependent claims.

### SUMMARY OF THE INVENTION

The invention relates to a device for filling and compacting powder or granules, in particular coffee powder, into a container, in particular into a coffee capsule, wherein the powder or granules are provided by a separate apparatus and wherein the device comprises:
a lateral surface, wherein the lateral surface extends around a central axis of the device, in particular wherein the central axis of the device corresponds to a longitudinal axis of the device,
at least one inlet opening for admitting the powder or granules into the device, wherein the at least one inlet opening extends within a cover surface of the device,
at least one outlet opening for discharging the powder or granules from the device into the container, wherein the at least one outlet opening extends within a base surface of the device,
an interior, wherein the interior
   is bounded at least by the lateral surface, and
   connects the inlet opening to the outlet opening, and
a movable plunger for compacting powder or granules contained in the container, wherein the plunger is arranged within the interior and is provided to be moved in a direction parallel to the central axis, in particular coaxially along the central axis,
   wherein the device further comprises:
at least one fastening element, wherein the at least one fastening element is provided to cooperate with a corresponding counterpart on the separate apparatus to provide temporary fastening of the device to the separate apparatus, and
at least one holding element, wherein the at least one holding element is provided to temporarily hold the container on the device, in particular wherein the holding element is designed such that the container can be held on the device at a distance of 0 mm to 50 mm and/or an opening of the container can be brought at least largely into coincidence with the outlet opening.

The fact that the device according to the invention can be flexibly detached from the separate apparatus and reattached allows the user to use the device as an independent appliance according to his needs and wishes. For example, if the user of the device according to the invention wishes to fill coffee powder into a coffee capsule and compact it there, he can, for example, fill already ground coffee powder into the device through the inlet opening using a spoon. The attachment of a coffee grinder, which provides the coffee powder by grinding, to the device (which would easily be possible via the fastening element) is therefore not mandatory. In this way, the device according to the invention can be used much more flexibly than comparable devices from the prior art, which cannot be separated from the grinder.

The device according to the invention can also be used with an electrically operated coffee grinder, preferably with an electric grinder with integrated scales. By means of such a grinder, the amount of coffee required or desired for filling the coffee capsule can be provided in a very short time, e.g. less than 2 seconds. The filling device can be positioned directly under the outlet of the grinder for this purpose. In this way, a capsule can be filled with the desired amount of coffee in a very short time. With a time-controlled coffee grinder, the grinding and filling of the capsule can be carried out similarly quickly and precisely. The filled coffee capsule can then be used directly afterwards to produce coffee in a specially designed coffee machine.

The production of a filled coffee capsule and the production of the coffee can thus be carried out comparatively quickly and repeatedly with reliable quality.

In an exemplary embodiment of the device according to the invention, the separate apparatus is designed as a grinder, in particular a coffee grinder, and/or the at least one holding element is arranged on the base surface.

Accordingly, a further advantage of the device is that the device can be connected to a separate coffee grinder (apparatus) with a precise fit. The device is designed in such a way that the ground coffee powder provided by the grinder can be introduced directly and cleanly into the coffee capsule (container) through the inlet opening, the interior and the outlet opening.

The compact design of the device and the modular combinability with the separate apparatus make it possible to provide a comparatively flexible and simple filling system.

In a further embodiment of the device, the at least one holding element is designed as a
tab,
groove,
fold,
slot,
mortise, or
notch,
   wherein an elevation arranged at the opening of the container and projecting perpendicularly to a central axis, in particular to a longitudinal axis, of the container can be reversibly inserted into the at least one holding element and thus the container can be temporarily held on the device.

In a further embodiment, the device further comprises a stand, wherein the stand is arranged on the base surface, or the lateral surface extends beyond the base surface in the direction parallel to the central axis and thus forms the stand of the device, in particular wherein the stand has an insertion opening through which the container can be positioned below the outlet opening and/or can be inserted into the at least one holding element.

In a further embodiment of the device, the base surface or the stand is designed in such a way that the device can stand freely on an approximately flat surface.

In a further embodiment of the device, the base surface or the stand has such a large diameter that the device is secured against tilting from a free-standing position when the plunger is moved.

In a further embodiment of the device, the plunger comprises a spring, wherein the spring provides a restoring force that acts in the direction of the inlet opening.

In a further embodiment of the device
the cover surface expands perpendicular to the central axis,
the base surface expands perpendicular to the central axis,
the inlet opening expands perpendicular to the central axis, and/or
the outlet opening expands perpendicular to the central axis.

In a further embodiment of the device, the diameter of the inlet opening is designed larger than the diameter of the outlet opening, in particular wherein the interior is funnel-shaped from the inlet opening to the outlet opening.

In a further embodiment, the device is designed to be handholdable and mobile, in particular wherein
the device has a height in the range from 6 cm to 14 cm, in particular from 8 cm to 12 cm,
the device has a width in the range from 2.8 cm to 10 cm, in particular in the range from 6 cm to 8 cm,
the device has a diameter in the range from 2.8 cm to 10 cm, in particular in the range from 6 cm to 8 cm,
the device has a weight in the range from 100 grams to 500 grams,
the inlet opening has a diameter in the range from 28 mm to 100 mm, in particular in the range from 60 mm to 80 mm,
the outlet opening has a diameter in the range from 28 mm to 50 mm, and/or
the outlet opening has a diameter that corresponds to the diameter of standard coffee capsule openings.

Because the device according to the invention is designed to be handholdable and mobile, it can be easily and conveniently transported by the user, for example when traveling where space in luggage is limited. In addition to the increased carrying comfort, this also provides the user with additional flexibility, as he can have the device available at all times and does not have to resort to alternative solutions.

In a further embodiment of the device, the at least one fastening element is arranged on the plunger, in particular on an end of the plunger that is less distant from the inlet opening, on the lateral surface and/or on the cover surface.

In a further embodiment of the device, the at least one fastening element is designed as a
magnet,
tenon,
eyelet,
hook,
tab,
loop,
screw,
prong,
burl, or
pushbutton, and/or
is made of a ferromagnetic material.

In a further embodiment of the device, the interior has a guide along which the plunger can be moved, wherein the guide provides a stop against which a section of the plunger projecting orthogonally to the central axis and moved along the guide meets after covering a defined distance and thus limits a movement distance of the plunger.

In a further embodiment of the device, the plunger is movable out of the interior through the outlet opening in the direction parallel to the central axis, in particular coaxially along the central axis, in particular wherein the movement of the plunger out of the interior through the outlet opening compacts the powder or granules located in the container held on the device by the at least one holding element by means of pressure exerted on the powder or granules by the plunger.

The invention also relates to a system comprising a handholdable grinder, in particular a coffee grinder, and a device as described above, wherein the handholdable grinder comprises at least one counterpart provided to cooperate with the corresponding fastening element of the device and thus provide a temporary fastening of the device to the grinder. In an exemplary embodiment of the system according to the invention, the handholdable grinder further comprises:
a housing, wherein the housing encloses a grinder interior, and a hollow shaft, in particular rotatable about a central axis of the housing, is arranged within the grinder interior,
a rotation means, in particular a handle rotatable about the central axis of the housing, is provided to provide the rotation of the hollow shaft,
a grinding cone, provided
   to be arranged within the grinder interior and spaced from the housing, and
   to be fixed, in particular non-rotatably,
in particular wherein the grinding cone is provided to be arranged coaxially to the central axis of the housing, and
a grinding rim, provided to be arranged on the hollow shaft and integrally formed on the grinding cone in such a way that
   the grinding rim is rotated around the grinding cone when the hollow shaft rotates,
   a cavity is formed between the grinding cone and the grinding rim, wherein the cavity is provided to receive a material to be ground, in particular coffee beans, which can pass through the hollow shaft into the cavity, and
   when the grinding rim rotates around the grinding cone, the ground material accommodated in the cavity is ground.

In a further embodiment of the system, the at least one counterpart is provided to be fixed, in particular non-rotatably, during rotation of the hollow shaft and the grinding rim, and to interact with a fastening element arranged on the plunger of the device, in particular on the end of the plunger that is less distant from the inlet opening, in particular wherein the at least one counterpart is provided to be arranged coaxially to the central axis of the housing.

In a further embodiment of the system, the central axis of the housing corresponds to a longitudinal axis of the housing.

The counterpart of the grinder can in particular be designed as a magnet. In particular, the counterpart of the grinder can be arranged at a lower end, i.e. the outlet side of the grinder provided for discharging the ground powder. In particular, the counterpart is arranged centrally, e.g. on the central axis.

The fastening element is designed to correspond to the counterpart in such a way that, when the device and apparatus are combined, a surface of the fastening element facing in the direction of the cover surface is at least largely, in particular completely, covered. Such a design can prevent a deposit from forming on the fastening element when the device is filled with powder or granules.

### BRIEF DESCRIPTION OF THE DRAWINGS

The device according to the invention and the system according to the invention are described in more detail below by way of purely exemplary embodiments shown schematically in the figures. Identical elements are marked in the figures with identical reference signs. The embodiments described are generally not shown to scale and are not to be understood as a limitation, wherein in detail:

FIG. 1: shows an exterior view of an exemplary embodiment of the device according to the invention;

FIG. 2: shows a view of a cross-section of an exemplary embodiment of the device according to the invention;

FIG. 3: shows a top view of an exemplary embodiment of the device according to the invention;

FIG. 4: shows a bottom view of an exemplary embodiment of the device according to the invention;

FIG. 5: shows an exterior view of an exemplary embodiment of the system according to the invention;

FIG. 6: shows a view of a cross-section of an exemplary embodiment of the system according to the invention;

FIG. 7: shows a perspective external view of an exemplary embodiment of the system according to the invention;

### DETAILED DESCRIPTION OF THE DRAWINGS

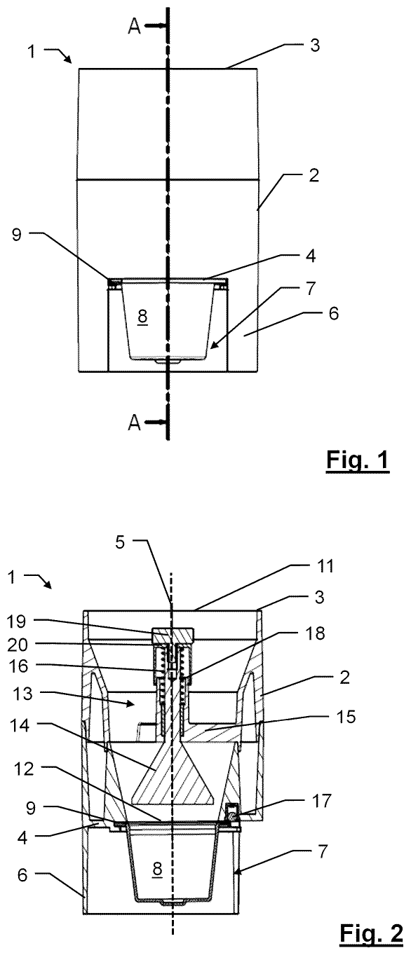

FIG. 1 shows an external view of an exemplary embodiment of the device 1 according to the invention. In the embodiment shown, the device 1 has an approximately cylindrical shape, which is formed from a lateral surface 2, a cover surface 3 and a base surface 4. The shape of the device 1 is not limited to that of a cylinder. In principle, the device can be realized in any shape that has a lateral, top and base surface. Examples of this are cubes, cuboids, prisms, truncated pyramids, etc.

The spatial extension of the device 1 is preferably selected so that the device 1 is handholdable and mobile. This is achieved in particular by manufacturing the cylindrical device 1 with a height of between 6 cm and 14 cm and a diameter of between 1.8 cm and 8 cm. Furthermore, the weight of the device 1 is preferably between 100 grams and 500 grams, which is ensured, inter alia, by the choice of the manufacturing materials of the device 1, in particular by the choice of the manufacturing materials of the lateral surface 2, cover surface 3 and base surface 4. Examples of such manufacturing materials are stainless steel, aluminum, wood, ceramics, glass and plastics (e.g. semi-crystalline thermoplastics such as polypropylene). The design of the device 1 as an appropriately dimensioned cylinder has the advantage that the device 1 can thus be held comfortably with one hand without the user having the feeling that the device 1 could slip out of the hand at any time or press corners or edges into the palm.

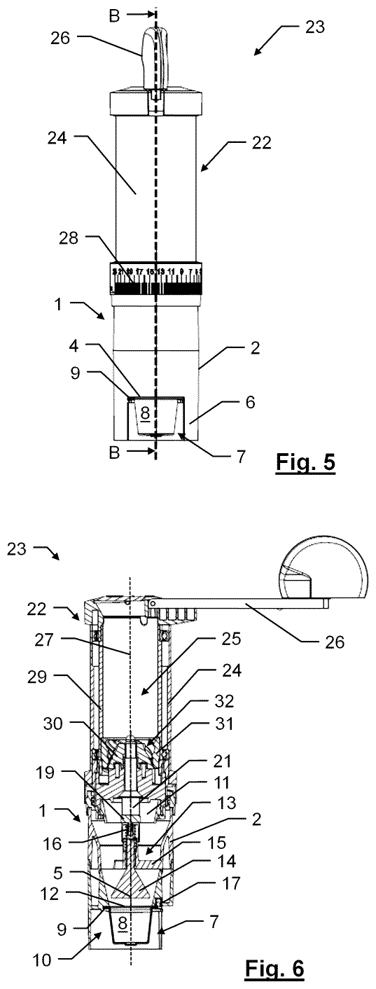

FIG. 1 shows the cross-sectional area A along which the cross-section of the device 1 shown in FIG. 2 is generated. The lateral surface 2 extends around/surrounds the central axis 5, in particular the longitudinal axis, of the device 1, wherein the central axis 5 is contained in the cross-sectional area A. Furthermore, the device 1 has a stand 6, with the lateral surface 2 extending beyond the base surface 4 in the direction parallel to the central axis 5 and thus forming the stand 6 of the device 1. Because the stand 6 is formed by the extension of the cylindrical lateral surface 2 beyond the base surface 4, the stand 6 has a cylindrical, hollow stand interior 10, which in the embodiment of the device 1 shown is not closed by a base plate and is therefore accessible from below when the device 1 is raised (see FIG. 4).

In the following, embodiments of the device 1 according to the invention are described by way of example in that the device 1 according to the invention is configured to fill coffee powder into a coffee capsule 8 and to compress the coffee powder filled into the coffee capsule 8. It is understood that the device according to the invention is also configured to fill other powdery or granular substances, such as spices or cereals, into a corresponding container, such as a spice jar, and to compress them there by means of the plunger. The field of application of the device according to the invention thus extends beyond the provision of filled coffee capsules.

In the embodiment of the device 1 shown, the stand 6 has an insertion opening 7 through which the container 8, which is shown in FIG. 1 and also in the following figures as a coffee capsule 8, is inserted into the holding element 9 arranged in the stand interior 10. The holding element 9 is exemplarily designed as a groove into which the edge of the coffee capsule opening projecting to the side (perpendicular to the central axis, in particular to the longitudinal axis, of the coffee capsule) is inserted, thus temporarily holding the coffee capsule 8 on the device 1. The insertion opening 7, which is formed as a cut-out in the lateral surface 2, allows the coffee capsule 8 to be inserted laterally to the device 1 through the lateral surface 2 into the holding element 9 located in the stand interior 10. Such a design of the stand 6 and insertion opening 7 has the advantage that the projecting edge of the coffee capsule opening can simply be pushed into the groove 9 and pulled out of the groove 9 even when the device 1 is standing on the stand 6, without the lateral surface 2 having to be opened in any way (e.g. by a door in the lateral surface) or the device 1 having to be lifted in order to make the stand interior 10 of the base accessible for the coffee capsule 8.

FIG. 2 shows a cross-section of an exemplary embodiment of the device 1 according to the invention along the cross-sectional area A of FIG. 1. The device 1 according to the invention has an inlet opening 11 through which, for example, coffee powder can be let into the device 1, wherein the inlet opening 11 extends within the cover surface 3. In the embodiment shown, the inlet opening 11 has such a large diameter that the remaining cover surface 3 surrounding the inlet opening 11 is almost completely formed by the lateral surface 2. The device 1 further comprises an outlet opening 12 for discharging the coffee powder from the device 1 into the coffee capsule 8, wherein the outlet opening 12 extends within the base surface 4. Since the exemplary embodiment of the device 1 shown is provided for filling coffee powder into coffee capsules and compacting it there, the outlet opening 12 is advantageously designed in such a way that its diameter corresponds (at least approximately) to that of conventional coffee capsule openings. In the advantageous embodiment shown, the groove 9 is arranged on the base surface 4 in such a way that the coffee capsule 8 is held on the device 1 with as little clearance as possible (advantageously with no clearance or with a clearance of 0 mm) and the coffee capsule opening is (at least largely) brought into alignment with the outlet opening 12. This ensures that the coffee powder which is discharged from the device 1 ends up in the coffee capsule and does not pass through openings or slots next to the coffee capsule. In this way, the device 1 according to the invention ensures that the coffee capsule 8 is filled cleanly and accurately with the desired amount of coffee powder.

A snap lock 17 is optionally arranged at the outlet opening 12, for example in the form of a slightly protruding, spring-loaded snap latch/snap tongue/pushbutton, which is pressed inwards by the projecting edge of the coffee capsule opening when the coffee capsule 8 is inserted into the holding element 9 and snaps back into its starting position as soon as the coffee capsule 8 has passed the snap lock 17 and is in the desired position. In this way, the coffee capsule 8 is not only held in the desired position by the holding element 9, which is designed as a groove (for example, so that the coffee capsule opening is aligned with the outlet opening 12), but also by the snap lock 17, which prevents the coffee capsule 8 from slipping out of the groove 9. This also ensures that the coffee capsule 8 is filled cleanly and accurately with the desired amount of coffee powder.

The device 1 according to the invention further comprises a hollow interior 13, wherein the interior 13 is defined by the lateral surface 2, cover surface 3 and base surface 4 and connects the inlet opening 11 to the outlet opening 12 in such a way that coffee powder, which has been let into the device 1 through the inlet opening 11, passes through the interior 13 to the outlet opening 12 and through the outlet opening 12 into the coffee capsule 8. In particular when the device 1 is set up, i.e. when the device 1 is standing on the stand 6 and the central axis 5 corresponds to a vertical axis, the coffee powder can trickle from the inlet opening 11 through the interior 13 and through the outlet opening 12 into the coffee capsule 8 due to gravity. It is particularly advantageous that the diameter of the inlet opening 11 is larger than the diameter of the outlet opening 12, which makes it easier to fill the coffee powder into the device 1. Due to the funnel-shaped design of the interior 13 towards the outlet opening 12, the coffee powder introduced is guided in a targeted manner to the coffee capsule opening without the need for additional effort. In the embodiment of the device 1 shown, the cover surface 3, the base surface 4, the inlet opening 11 and the outlet opening 12 extend perpendicular to the central axis.

FIG. 2 also shows the movable plunger 14 for compacting the coffee powder in the coffee capsule 8, the guide 15 along which the plunger 14 is moved and the spring 16, which provides a restoring force that acts in the direction of the inlet opening 11. The components 14, 15 and 16 are arranged within the interior 13. The guide 15 is connected to the lateral surface 2 via struts and therefore also serves to align the plunger 14 and the spring 16 (e.g. coaxially to the central axis 5) and to hold them in their aligned position. If a force coaxial to the central axis 5 now acts in the direction of the outlet opening 12 on the upper end of the plunger 14 marked with reference sign 19, i.e. on the end of the plunger 14 that is less distanced from the cover surface 3 or the inlet opening 11, the plunger 14 is moved in the direction of the outlet opening 12 along the guide 15, which is designed as a kind of channel/tube in which at least a part of the plunger 14 extends and thus determines the direction of movement of the plunger 14. This movement of the plunger 14 extends coaxially along the central axis 5, wherein a section 20 of the plunger 14 projecting orthogonally to the central axis 5 presses on the spring 16 and compresses or compresses it. The plunger 14 can be moved along the guide 15 and thus also along the central axis 5 in the direction of the outlet opening 12 until the projecting section 20 meets a stop 18 provided by the guide 15. In this way, the movement path of the plunger 14 within the inner chamber 13 is limited. The compressed spring 16 provides a restoring force, which ensures that the plunger 14 is moved back to its starting position as soon as the force acting coaxially to the central axis 5 in the direction of the outlet opening 12 decreases again. In a preferred embodiment of the device 1, the interaction of the components 14, 15, 18 and 20 is such that the distance of movement of the plunger 14 is such that the plunger 14 can be moved coaxially along the central axis through the outlet opening 12 out of the interior 13 and can thus exert pressure on the coffee powder which is located in the coffee capsule 8 held on the device 1 by the holding element 9.

The exemplary embodiment of the device 1 according to the invention further comprises a fastening element 19, wherein the fastening element 19 is provided to cooperate with a corresponding counterpart 21 on a coffee grinder 22 and thus provide a temporary fastening of the device 1 to the coffee grinder 22. The fastening element 19 is arranged at the end of the plunger 14 that is less distant from the inlet opening 11. However, further embodiments of the device 1 according to the invention can also be realized, in which further fastening elements (in addition to or instead of the fastening element 19) are arranged, for example, on the lateral surface 2 and/or on the cover surface 3. The fastening element 19 can be designed as a magnet and the counterpart 21 can be made of a ferromagnetic material (or vice versa), whereby a fastening of the device 1 to the coffee grinder 22 is provided by the acting magnetic attraction force of the components 19 and 21. However, a purely mechanical interaction of the components 19 and 21 can also be realized, for example by the fastening element 19 being designed as a hook and the counterpart 21 as an eyelet. A design of the components 19 and 21 as a magnet and ferromagnet has the advantage that the device 1 can be removed/pulled off the coffee grinder 22 simply by applying a force that counteracts the magnetic attraction force, without the need to laboriously unthread a hook from an eyelet, for example.

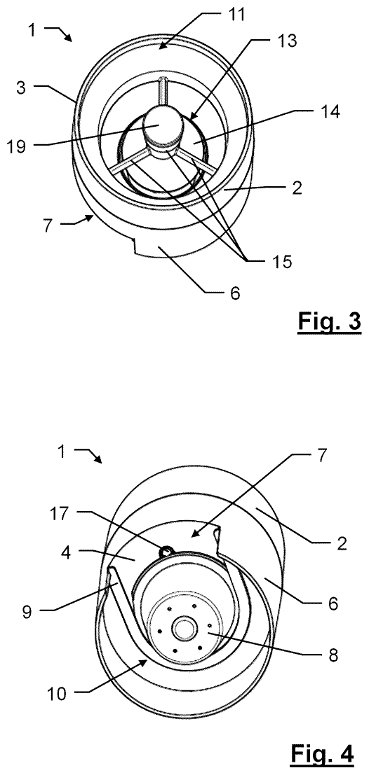

FIG. 3 shows a top view of an exemplary embodiment of the device 1 according to the invention. It can be seen here that the inlet opening 11 expands with such a large diameter within the cover surface 3 that the cover surface 3 is almost completely reduced to an expansion corresponding to the wall thickness of the casing 2. Furthermore, the interior 13 is shown, in which the plunger 14 and the guide 15 are arranged. The guide 15 is designed as a type of tube, which is connected to the casing 2 by cross struts and is thus fixed within the interior 13 in such a way that the plunger 14, which is arranged at least partially within the tube, can only be moved coaxially along the central axis 5. In this way, targeted movement/pressing of the plunger 14 onto the coffee powder in the coffee capsule 8 is ensured.

Since the fastening element 19, the plunger 14 and the guide 15 are arranged coaxially along the central axis 5 in the interior 13 and their extension is limited orthogonally to the central axis 5, the coffee powder admitted into the interior 13 through the inlet opening 11 can pass laterally past the components 19, 14 and 15 to the outlet opening 12 without there being any surfaces on which coffee powder can deposit. Such a deposit of coffee powder within the device 1 would, on the one hand, lead to soiling or even clogging of the device 1 and, on the other hand, to deviations in the amount of coffee powder filled into the coffee capsule 8. For this reason, the cross struts of the guide 15 are advantageously designed to be particularly narrow and tapered in order to avoid forming any deposit areas for coffee powder. One of the purposes of the funnel-shaped design of the interior 13 is to ensure that the coffee powder trickles in the direction of the outlet opening 12, thereby also preventing coffee powder from depositing in the device 1.

FIG. 4 shows a bottom view of an exemplary embodiment of the device 1 according to the invention. It can be seen here that the stand 6 is formed by the lateral surface 2 extending beyond the base surface 4 in the direction parallel to the central axis 5. The hollow stand interior 10 is formed within the cylindrical stand 6, wherein the stand 6 has a cut-out at one point which forms the insertion opening 7. The coffee capsule 8 can be inserted into the holding element 9 through the insertion opening 7, wherein the holding element 9 in the embodiment shown is designed as a semi-circular groove (U-shaped), which is arranged on the base surface 4. The laterally protruding edge of the coffee capsule opening is inserted into the groove 9 and the coffee capsule 8 is then pushed (horizontally) along the groove 9 until it has reached the end position defined by the U-shape of the groove 9.

If the coffee capsule 8 is pushed/pressed along the groove 9 with the fingers, a first point of the edge of the coffee capsule 8 projecting laterally towards the coffee capsule opening meets the snap latch of the snap lock 17, which is pressed into a recess let into the base surface 4 by the pressure transmitted by the finger to the edge of the coffee capsule opening. In this way, the coffee capsule 8 can then be pushed in further (horizontally), wherein as soon as the first point of the edge projecting laterally towards the coffee capsule opening has passed the snap lock, the latter snaps out of the recess again. If the coffee capsule 8 is then pushed further along the groove 9 to the specified end position, the snap latch is pressed back into its recess by the opposite second point of the projecting edge until this second point has also passed the snap latch. The snap latch of the latching device 17 thus serves to additionally fix the coffee capsule at the predetermined end position and, in addition to the groove 9, prevents the coffee capsule from slipping during the filling and/or compacting process and coffee powder from escaping from the device 1 and/or the coffee capsule 8 in an undesirable manner.

In the end position, the coffee capsule opening is vertically below and largely congruent with the outlet opening 12 (deviation of at most a few millimeters, in particular a deviation of at most 3 mm), which preferably has a diameter that approximately corresponds to the diameter of the coffee capsule opening (deviation of a few millimeters, in particular a deviation of at most 3 mm). Furthermore, the groove 9 is arranged so close (preferably at no distance) to the base surface 4 that, when the coffee capsule 8 is inserted, there is virtually no slit/gap (preferably a gap width of at most 3 mm) between the inserted coffee capsule 8 and the outlet opening 12 and thus no coffee powder can escape from the device 1 past the coffee capsule 8.

After the coffee powder has been filled into the inserted coffee capsule 8 and compacted by means of the plunger, the filled coffee capsule 8 can be pushed back/pressed back in the direction of the insertion opening 7 using a finger, for example. The resulting pressure exerted by the projecting edge of the coffee capsule opening on the snap latch of the latching device 17 is sufficient to press the resiliently mounted snap latch into its recess in the base surface 4, allowing the filled coffee capsule 8 to be removed from the holding element 9.

In the following, embodiments of the system 23 according to the invention are described by way of example in that the handholdable grinder 22 (previously also referred to as separate apparatus 22 by way of example) is designed as a coffee grinder and thus provides coffee powder, which is filled into a coffee capsule 8 by means of the device 1 according to the invention and compacted there. It is understood that the handholdable grinder 22 is designed to grind not only coffee beans but also other coarse-grained ground material, such as peppercorns or cereal grains, and to let the pepper or cereal powder produced in this way, for example, into the device 1 through the inlet opening 11. As already described above, the device 1 according to the invention is also configured to fill this pepper or cereal powder (exemplary for other powdery or granular substances) into a corresponding container, such as a spice jar, and to compact it there by means of the plunger 14. The field of application of the system 23 according to the invention thus extends beyond the provision of coffee capsules filled with freshly ground coffee powder.

FIG. 5 shows an external view of an exemplary embodiment of the system 23 according to the invention. In this exemplary embodiment of the system 23 according to the invention, the device 1 described in FIGS. 1 to 4 is at least temporarily attached to the handholdable coffee grinder 22 by the interaction of the fastening element 19 with the counterpart 21, with the coffee grinder 22 providing the coffee powder which is filled into the coffee capsule 8 by means of the device 1 and compacted there.

If the user of the system 23 wishes to use only one of the two parts of the system 23, he can simply disconnect the components 19 and 21 from each other and thus separate the coffee grinder 22 from the device 1. This reversible connection/separation of device 1 and coffee grinder 22 allows the user:
to use the device 1 without the coffee grinder 22, for example if he already has ground coffee powder available,
to use the device 1 together with the coffee grinder 22, for example, if he has coffee beans available and wants to fill a coffee capsule with this coffee, or
to use the coffee grinder 22 without the device 1 if he has coffee beans available and wants to brew a filter coffee with them, for example.

This separability of the parts of the system 23 according to the invention enables very flexible applicability and thus eliminates significant disadvantages of the prior art.

FIG. 5 also shows the housing 24 of the coffee grinder 22, wherein the housing 24 is cylindrical in shape (one advantage of the cylindrical shape of the housing 24 is that it enables a comfortable hand position without corners and/or edges pressing into the hand) and encloses a grinder interior 25, and the rotation means 26, designed as a handle 26 that can be rotated about the central axis 27 of the housing 24. The central axis 27, in particular the longitudinal axis, of the hand grinder 22 is contained in the cross-sectional area B. Furthermore, the embodiment of the hand grinder 22 shown has the adjusting wheel 28, with which the degree of grinding of the coffee powder provided by the coffee grinder 22 can be set with millimeter precision and reproducibly. Alternatively, an embodiment of the system 23 according to the invention can also be realized, in which at least one fastening element 19 is arranged on the cover surface 3 and/or on the lateral surface 2 of the device 1 and at least one counterpart 21 is arranged on the shell of the housing 24.

FIG. 6 shows a cross-section of an exemplary embodiment of the system according to the invention along the cross-sectional area B of FIG. 5. Since the embodiment of the device 1 shown in FIGS. 5 and 6 is an embodiment according to FIGS. 1 to 4, the device 1 will not be discussed again in the following description of the figures.

As already mentioned, the exemplary embodiment of the system 23 according to the invention comprises the handholdable coffee grinder 22 and the device 1, wherein these two parts are temporarily connected to one another by the interaction of the fastening element 19 of the device 1 with the counterpart 21 of the coffee grinder 22. The handholdable coffee grinder 22 has the cylindrical housing 24, wherein the housing 24 encloses the grinder interior 25. The hollow shaft 29 is arranged within the grinder interior 25, wherein the hollow shaft 29 in this exemplary embodiment of the system 23 according to the invention is also cylindrical and rotates about the central axis 27 of the housing 24. This rotation of the hollow shaft 29 is provided by the rotatable handle 26.

Within the grinder interior 25, the grinding cone 30 is also arranged coaxially to the central axis 27 and at a distance from the housing 24, wherein the grinding cone 30 is fixed in the grinder interior 25 in such a way that the grinding cone 30 does not rotate when the handle 26 and the hollow shaft 29 rotate. The grinding rim 31, on the other hand, is arranged on the hollow shaft 29 and is thus rotated around the grinding cone 30 when the hollow shaft 29 rotates. The grinding rim 31 is also integrally formed on the grinding cone 30 in such a way that the cavity 32 is formed between them, wherein coffee beans located in the cavity are ground when the grinding rim 31 rotates around the grinding cone 30. The coffee beans can be poured through an opening in the cover surface (the surface at the end of the grinder 22 to which the handle 26 is attached) into the grinder interior 25, in particular into the interior of the hollow shaft 29, and then fall through the hollow interior of the hollow shaft 29 into the cavity 32.

In the embodiment of the system 23 shown, the counterpart 21 is arranged coaxially to the central axis 27 and does not co-rotate when the hollow shaft 29 and the grinding rim 31 rotate. Furthermore, the counterpart 21 is arranged at the lower end of the coffee grinder 22, i.e. at the end of the coffee grinder 22 which is opposite the end of the coffee grinder 22 having the handle 26. This enables interaction with the fastening element 19, which is arranged at the end of the plunger 14 that is less distant from the inlet opening 11.

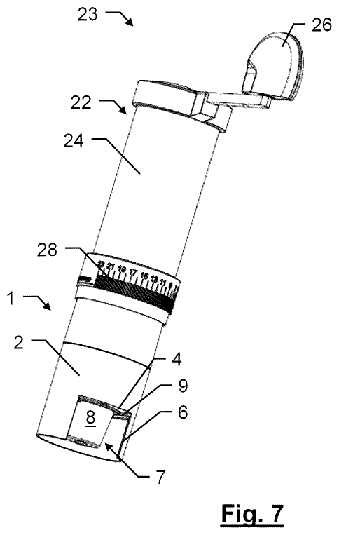

FIG. 7 shows an external perspective view of an exemplary embodiment of the system according to the invention for further illustration.

It should be understood that the figures shown are only schematic representations of possible embodiments. The various approaches can also be combined with each other and with prior art methods.

1. Device for filling and compacting powder or granules, in particular coffee powder, into a container, in particular into a coffee capsule, wherein the powder or granules can be provided by a separate apparatus and wherein the device comprises:
a lateral surface, wherein the lateral surface extends around a central axis of the device, in particular wherein the central axis of the device corresponds to a longitudinal axis of the device,
at least one inlet opening for admitting the powder or granules into the device, wherein the at least one inlet opening extends within a cover surface of the device,
at least one outlet opening for discharging the powder or granules from the device into the container, wherein the at least one outlet opening extends within a base surface of the device,
an interior, wherein the interior
is bounded at least by the lateral surface, and
connects the inlet opening to the outlet opening, and
a movable plunger for compacting powder or granules contained in the container, wherein the plunger is arranged within the interior and is provided to be moved in a direction parallel to the central axis, in particular coaxially along the central axis,
at least one fastening element, wherein the at least one fastening element is provided to cooperate with a corresponding counterpart on the separate apparatus and thus provide a temporary fastening of the 24 device to the separate apparatus, and
at least one holding element, wherein the at least one holding element is provided to temporarily hold the container on the device, in particular wherein the holding element is designed such that the container can be held on the device at a distance of 0 mm to 50 mm.

2. Device according to claim 1, wherein
the separate apparatus is designed as a grinder, in particular a coffee grinder, and
the at least one holding element is arranged on the base surface.

3. Device according to claim 1, wherein the at least one holding element is selected from a group consisting of
tab,
groove,
fold,
slot,
mortise, and
notch,
wherein an elevation arranged at the opening of the container and projecting perpendicularly to a central axis, in particular to a longitudinal axis, of the container can be reversibly inserted into the at least one holding element and whereby the container can be temporarily held on the device.

4. Device according to claim 1, wherein the device further comprises a stand, wherein
the lateral surface extends beyond the base surface in the direction parallel to the central axis and thus forms the stand of the device,
in particular wherein the stand has an insertion opening through which the container
can be positioned below the outlet opening, and
can be inserted into the at least one holding element.

5. Device according to claim 1, wherein the plunger comprises a spring, wherein the spring provides a restoring force that acts in the direction of the inlet opening.

6. Device according to one claim 1, wherein
the cover surface expands perpendicular to the central axis,
the base surface expands perpendicular to the central axis,
the inlet opening expands perpendicular to the central axis, and
the outlet opening expands perpendicular to the central axis.

7. Device according to claim 1, wherein the diameter of the inlet opening is designed larger than the diameter of the outlet opening, in particular wherein the interior is funnel-shaped from the inlet opening to the outlet opening.

8. Device according to claim 1, wherein the device is designed to be handholdable and mobile, in particular wherein
the device has a height in the range from 6 cm to 14 cm,
the device has a width in the range from 2.8 cm to 10 cm,
the device has a diameter in the range from 2.8 cm to 10 cm,
the device has a weight in the range from 100 grams to 500 grams,
the inlet opening has a diameter in the range from 28 mm to 100 mm, the outlet opening has a diameter in the range from 28 mm to 50 mm, and
the outlet opening has a diameter that corresponds to the diameter of standard coffee capsule openings.

9. Device according to claim 1, wherein the at least one fastening element is arranged at a location selected from a group consisting of:
on the plunger, in particular on an end of the plunger that is less distant from the inlet opening,
on the lateral surface, and
on the cover surface.

10. Device according to claim 1, wherein the at least one fastening element is selected from a group consisting of
magnet,
tenon,
eyelet,
hook,
tab,
loop,
screw,
prong,
burl, and
pushbutton, and wherein the at least one fastening element
is made of a ferromagnetic material.

11. Device according to claim 1, wherein the interior has a guide along which the plunger can be moved, wherein the guide provides a stop on which a section of the plunger projecting orthogonally to the central axis and moved along the guide meets after covering a defined distance and thus limits a movement distance of the plunger.

12. Device according to claim 1, wherein the plunger is movable out of the interior through the outlet opening in the direction parallel to the central axis, in particular coaxially along the central axis, in particular wherein the movement of the plunger out of the interior through the outlet opening compacts the powder or granules located in the container held on the device by the at least one holding element by pressure exerted on the powder or granules by the plunger.

13. System comprising a handholdable grinder, in particular a coffee grinder, and a device comprising
a lateral surface, wherein the lateral surface extends around a central axis of the device, in particular wherein the central axis of the device corresponds to a longitudinal axis of the device,
at least one inlet opening for admitting the powder or granules into the device, wherein the at least one inlet opening extends within a cover surface of the device,
at least one outlet opening for discharging the powder or granules from the device into the container, wherein the at least one outlet opening extends within a base surface of the device,
an interior, wherein the interior
a. is bounded at least by the lateral surface, and
b. connects the inlet opening to the outlet opening,
a movable plunger for compacting powder or granules contained in the container, wherein the plunger is arranged within the interior and is provided to be moved in a direction parallel to the central axis, in particular coaxially along the central axis,
at least one fastening element, wherein the at least one fastening element is provided to cooperate with a corresponding counterpart on the separate apparatus and thus provide a temporary fastening of the device to the separate apparatus, and
at least one holding element, wherein the at least one holding element is provided to temporarily hold the container on the device;
wherein the handholdable grinder comprises at least one counterpart provided to cooperate with the corresponding fastening element of the device and thus provide a temporary fastening of the device to the grinder.

14. System according to claim 13, wherein the handholdable grinder further comprises:
a housing, wherein the housing encloses a grinder interior, and a hollow shaft, in particular rotatable about a central axis of the housing, is arranged within the grinder interior,
a handle rotatable about the central axis of the housing, is provided to provide the rotation of the hollow shaft,
a grinding cone, provided
to be arranged within the grinder interior and spaced from the housing, and
to be fixed, in particular non-rotatably,
in particular wherein the grinding cone is provided to be arranged coaxially to the central axis of the housing, and
a grinding rim, provided to be arranged on the hollow shaft and integrally formed on the grinding cone in such a way that
the grinding rim is rotated around the grinding cone when the hollow shaft rotates,
a cavity is formed between the grinding cone and the grinding rim, wherein the cavity is provided to receive a material to be ground, in particular coffee beans, which can pass through the hollow shaft into the cavity, and
when the grinding rim rotates around the grinding cone, the ground material accommodated in the cavity is ground.

15. System according to claim 13, wherein the at least one counterpart is provided
to be fixed, in particular non-rotatably, during rotation of the hollow shaft and the grinding rim, and
to interact with a fastening element arranged on the plunger of the device, in particular on the end of the plunger that is less distant from the inlet opening,
in particular wherein the at least one counterpart is provided to be arranged coaxially to the central axis of the housing.
